(19) United States
(12) Patent Application Publication
(10) Pub. No.: US 2011/0320277 A1
(43) Pub. Date: Dec. 29, 2011

(54) Network-Based Information and Advertising System

(76) Inventor: Charles H. Isaacs, San Jose, CA (US)

(21) Appl. No.: 12/893,316

(22) Filed: Sep. 29, 2010

Related U.S. Application Data
(60) Provisional application No. 61/358,130, filed on Jun. 24, 2010.

(51) Int. Cl. G06Q 30/00; G06F 15/16; G06F 3/048

(52) U.S. Cl. 705/14.55; 715/760; 709/206

(57) ABSTRACT

A network-connected server has software executing from a machine-readable medium for providing functionality, a web page with links to one or more further pages providing information or services related to a first enterprise hosting the server, an interface for communicating with a computerized appliance accessing the web page with a web browser; and functionality in the software for adding to the browser display at the computerized appliance an interactive interface not provided on the web page, the interactive interface providing one or more links to specific information or services.

### CROSS-REFERENCE TO RELATED DOCUMENTS

The present invention is a Non-Provisional application of U.S. Provisional application 61/358,130, filed on Jun. 24, 2010. The disclosure of priority application is incorporated herein at least by reference.

### BACKGROUND OF THE INVENTION

1. Field of the Invention

The present invention is in the field of telephony, more particularly, contact center services, and pertains particularly to methods and apparatus for enabling realtime interaction between a customer and a business over a communications network.

2. Discussion of the State of the Art

In the field of telephone communications, there are contact center service providers who provide customer contact services for business clients who are generally classified as any business selling products or services. In customer relations management (CRM), it is very important that customers have unfettered access to all of the information they need to make a decision whether to buy products or services offered by the particular business with which they are dealing.

A problem in the art is that important access channels to required information or live assistance are not always immediately available on the welcoming (Home) page of a business website serviced by contact center services, or on another page to which a user might connect. For example, a contact page may be provided for visitors to make contact with contact center agents, service personnel, or knowledge workers including other experts, or with sources of information, however rarely is that page the first page encountered when a visitor logs into the site. Depending on the complexity and organization of the site, for which there seems to be no standardization, a visitor may become confused and frustrated attempting to navigate to a portion of the site where they can get assistance like live chat, for example.

Therefore, what is clearly needed is a system for enabling realtime contact information and other relevant information to pass directly from the contact center resource into a visitor's browser application or graphics user interface (GUI) immediately when an enabled website is visited, such that no intermediate navigation is required before establishing a live connection or partaking in other offered services and relevant advertisements provided by the contact center or relevant business entity.

### SUMMARY OF THE INVENTION

In an embodiment of the invention a network-connected server is provided, comprising software executing from a machine-readable medium for providing functionality, a web page with links to one or more further pages providing information or services related to a first enterprise hosting the server, an interface for communicating with a computerized appliance accessing the web page with a web browser, and functionality in the software for adding to the browser display at the computerized appliance an interactive interface not provided to all who visit the web page, the interactive interface providing one or more links to specific information or services.

In one embodiment the links to specific information or services are links to facilities hosted by the server. Also in one embodiment one or more of the links to specific information or services connect the computerized appliance to a different network-connected server. Also in an embodiment one or more of the links to specific information or services launches an IP telephone call to an agent at a call center hosted by a second enterprise acting on behalf of the first enterprise. In another embodiment one or more of the links to specific information or services connects the computerized appliance to a chat session. Still further, one or more of the links to specific information or services connects the computerized appliance to a service at a call center hosted by a second enterprise acting on behalf of the first enterprise, and to a facility for scheduling a call-back to an IP address or a telephone number. And further still, one or more of the links to specific information or services launches an email client at the computerized appliance with a pre-stored send-to address.

In some embodiments one or more of the links to specific information or services connects the computerized appliance to a service at a call center hosted by a second enterprise acting on behalf of the first enterprise, and to a facility for participating in a co-browsing session with an agent at the call center. Also in some embodiments the interactive interface provided to the browser of a connecting computerized appliance is provided on a selective basis, according to information provided by the connecting appliance, or stored at the server about the appliance or a person associated with the appliance. Further in some embodiments the server or a third party server to which the computerized appliance may be redirected, downloads an advertisement to the computerized appliance, the advertisement enhanced with interactive links providing the person using the appliance access to more granular material about a product or service subject of the advertisement, and an ability to buy the product or service.

In another aspect of the invention a method for customer interaction with a site hosted by an enterprise is provided, comprising steps of (a) connecting to the site by a computerized appliance executing a browser application; (b) providing to the computerized appliance through the browser application a web page; (c) providing to the browser application an interactive interface having links, not displayed on the web page to every visitor, to specific information or services.

In one embodiment the links to specific information or services are links to facilities hosted by the server. Also in one embodiment one or more of the links to specific information or services connect the computerized appliance to a different network-connected server. Also in an embodiment one or more of the links to specific information or services launches an IP telephone call to an agent at a call center hosted by a second enterprise acting on behalf of the first enterprise.

In some embodiments one or more of the links to specific information or services connects the computerized appliance to a chat session. Further in some embodiments one or more of the links to specific information or services connects the computerized appliance to a service at a call center hosted by a second enterprise acting on behalf of the first enterprise, and to a facility for scheduling a call-back to an IP address or a telephone number. In some embodiments one or more of the links to specific information or services launches an email client at the computerized appliance with a pre-stored send-to address.

Also in some embodiments one or more of the links to specific information or services connects the computerized appliance to a service at a call center hosted by a second enterprise acting on behalf of the first enterprise, and to a facility for participating in a co-browsing session with an agent at the call center. The interactive interface provided to the browser of a connecting computerized appliance may be provided on a selective basis, according to information provided by the connecting appliance, or stored at the server about the appliance or a person associated with the appliance. Further the server or a third party server to which the computerized appliance may be redirected, may download an advertisement to the computerized appliance, the advertisement enhanced with interactive links providing the person using the appliance access to more granular material about a product or service subject of the advertisement, and an ability to buy the product or service.

### BRIEF DESCRIPTION OF THE DRAWING FIGURES

FIG. 1 is an architectural overview of a communications network supporting dynamic toolbar installation and activation according to an embodiment of the present invention.

FIG. 2 is a plan view of an option launch container in the form of a browser toolbar according to an embodiment of the present invention.

FIG. 3 is a process flow chart illustrating steps for enabling dynamic option container installation and information conveyance through toolbar channels according to an embodiment of the present invention.

FIG. 4 is a plan view of a configuration interface for configuring or updating settings according to an embodiment of the present invention.

FIG. 5 is a process flow chart illustrating steps for customer interaction with a dynamic option toolbar according to an embodiment of the present invention.

FIG. 6 is an architectural overview of a communications network supporting dynamic business to user connectivity according to another aspect of the invention.

FIG. 7 is a plan view of a mobile device displaying an advertisement including a dynamic option load button according to an embodiment of the present invention.

FIG. 8 is a process flow chart illustrating steps for interacting with mobile advertisements according to an embodiment of the present invention.

### DETAILED DESCRIPTION

The inventors provide a unique system for enabling direct interaction with contact and search options for a company providing contact center services to business customers. The system is characterized by a automatic and sometimes temporary toolbar installation followed by an automated connection and download of the information to the toolbar installation. The various aspect of the present invention are described in enabling detail using the following examples, which may describe more than one embodiment of the present invention.

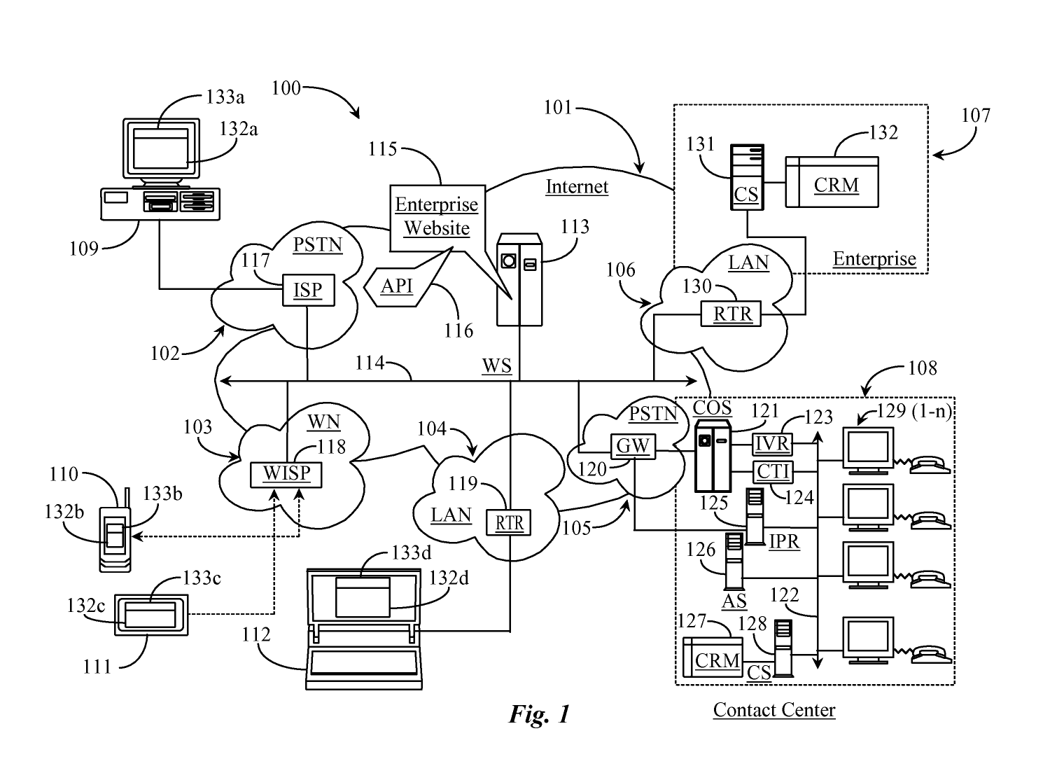

FIG. 1 is an architectural overview of a communications network 100 supporting dynamic toolbar installation and activation according to an embodiment of the present invention. Communication network 100 includes the well-known Internet network 101 including one or more connected sub-network through which Internet access is typically accomplished. Internet network 101 is further characterized by a network backbone 114. Backbone 114 represents all of the lines, equipment, and access points that make up the Internet as a whole including connected sub-networks. Therefore, there are no geographic limitations to the practice of the present invention.

Internet 101 is a carrier network in this example and provides access to a business or enterprise website 115 for customers of that Website. Website 115 represents any business Website maintained as a customer accessible site by an enterprise such as enterprise 107. Website 115 is installed on and executable from a web server 113 connected to backbone 114. Web server 113 represents any computing server having a digital medium provided thereon or otherwise accessible thereto adapted to store the software and data required to enable function as a Web server.

Enterprise 107 has a customer information server 131 connected to a local area network (LAN) 106. Information server 131 is adapted with a digital medium for storing the software and data required to enable server function as a centralized data server. LAN 106 is connected to network backbone 114 through a data router 130. A data repository 132 is provided and is adapted as a customer relations management (CRM) repository connected to server 131. Repository 132 may store customer data and other information about customers of the enterprise such as billing information, contact data, purchase history, contact history, demographics, and any other customer information that might be considered important to the enterprise. Web server 113 may be hosted by enterprise 107 or by a third-party Web hosting business.

Enterprise 107 represents any business that sells products and/or services. In this example enterprise 107 contracts out some of or all of its customer contact services to a third-party provider such as a contact center 108. Contact center 108 is under contract with enterprise 107 to service the customers of the enterprise in one both of sales and services. In this respect, contact center 108 has a local area network (LAN) 122 adapted as a sub-network having connection to Internet backbone 114. Contact center 108 provides full customer contact services on behalf of enterprise 107. Such services may include but are not limited to answering calls and communicated questions, proactive contact services, chat services, live telephone sales and services, email services, knowledgebase access services, and other like services that may be pursued in the light of helping customers of enterprise 107 fulfill their needs.

LAN 122 supports a number of agent workstations 129 (1-n) coupled to LAN 122 within contact center 108. Contact center 108 may be a single physical contact center or an access point in a federated contact center environment without departing from the spirit and scope of the present invention. Each workstation 122 1-n includes a computing device such as a personal computer and a telephone capability. Telephones may be digital IP phones, VoIP headsets, analog telephones sets etc. State-of-art contact center services include voice services, messaging services, live chat, co-browsing, and automated order processing. Workstations 129 (1-n) may be assumed capable of all types of contact center communications with customers of any contracting business relative to the products and services of those businesses.

Contact center 108 includes a central office switch 121 adapted for computer telephony integration (CTI) by a connected CTI processor 124. CTI processor 124 provides a level of intelligence to switch 121 enabling intelligent routing routines and other smart functions. CTI processor 124 is connected to LAN 122 and to switch 121. Switch 121 may be an automated call distributor (ACD) a private branch exchange (PBX) or some other type of telephony switching facility without departing from the spirit and scope of the present invention. Switch 121 has connection to a PSTN network segment 105 and may have trunk connections to one or more local and remote telephone switching facilities (not illustrated) within the PSTN. Callers accessing switch 121 from the Internet side are routed through a gateway 120 that effectively bridges communication between the telephone and Internet networks.

Contact center 108 utilizes an interactive voice response (IVR) capability implemented at switch 121 within an IVR system 123. IVR 123 is used to screen customer calls coming into to center 108 from anywhere outside the center. Contact center 108 has an application server 126 connected to LAN 122. Server 126 includes a digital medium that contains all of the software and data required to enable function as an application server. Server 126 is adapted to contain and serve customer contact applications used in conjunction with IVR services to interact with callers. Contact center 108 may also employ proactive customer contact such as outbound contact services, proactive chat invitations, email contact services, and so on.

Contact center 108 includes an Internet Protocol router 125 having LAN connection in this example and connection to gateway 120 in PSTN segment 105. Digital correspondence such as messaging, VoIP, chat requests, IM requests, and any other interactive communications may come into the center through gateway 120, which may be a multimedia gateway. Contact center 108 includes a customer information server 128 connected to LAN 122 and to a customer relations management (CRM) repository 127. Repository 127 is adapted to contain information about clients of the contact center including all of the client businesses it represents and records surrounding all of the customer contacts made in conjunction with servicing those client businesses. Other types of equipment may be represented within contact center 108 without departing from the spirit and scope of the present invention such as a routing server, a workforce management server, an outbound contact server, and like equipment.

Customers of enterprise 107 are illustrated in this example as a customer 109 (PC), a customer 110 (Cellular Phone), a customer 111 (PDA), and a customer 112 (Laptop). Customer 109 has access through a PSTN segment 102 and an Internet Service Provider (ISP) 117. Customer 110 has access through a wireless network 103 and a wireless Internet service provider (WISP) 118. Wireless network 103 may be a Wireless Fidelity network, or a wireless telephone carrier network. Customer 111 may have access to Internet 101 through wireless network 103 as does customer 110. Customer 112 has access to Internet 101 via a LAN 104 and a router 119. There are numerous connection methods available and known to the inventors. In general, access to server 113 and Website 115 is browser-based access. The differing computing appliances in this example are all markedly different devices having a slightly differing version of a browser.

Customer 109 has a browser application 132a installed in working order. Browser application 132a may be any sort of Web navigation application without departing from the spirit and scope of the present invention. Browser application 132a has a toolbar area 133a including search options, network navigation address bar, and other typical interactive mechanisms that may come with or may be added to the basic browser application. Customer 110 has a browser application 132b with a browser toolbar area 133b. Customer 111 accesses web server 113 using browser application 132c having a toolbar area 133c. Customer 112 accesses web server 113 using browser application 132d with toolbar area 133d. Each browser application may be different, such as its own version adaptable to the host upon which it runs. The importance of having a toolbar area appear in the browser application is self evident, in that much information is presented at the user's fingertips and can be accessed through browser navigation controls as is typically the case with all browser-based applications.

In practice of the present invention, users or potential customers of enterprise 107 including customers 109-112 may, during the course of regular business, access enterprise Website 115 running on web server 113. Website 115 of enterprise 107 running on web server 113 has an application program interface (API) 116 installed and executable thereon. API 116 is adapted to enable Website 115 to host an automated toolbar installation process that installs, under certain conditions, an option launch container (toolbar version) into each browser of a Website visitor such as connected browsers operated by customers 109-112. API 116 is invoked by browser execution of certain code on the site. Invoking API 116 causes the option launch container (not illustrated) to install temporarily while the user is browsing the enterprise Website. To the extent that there may be differing versions of the option launch container for different browsers and/or operating systems and devices, the installation process determines which version will be supported on the destination system.

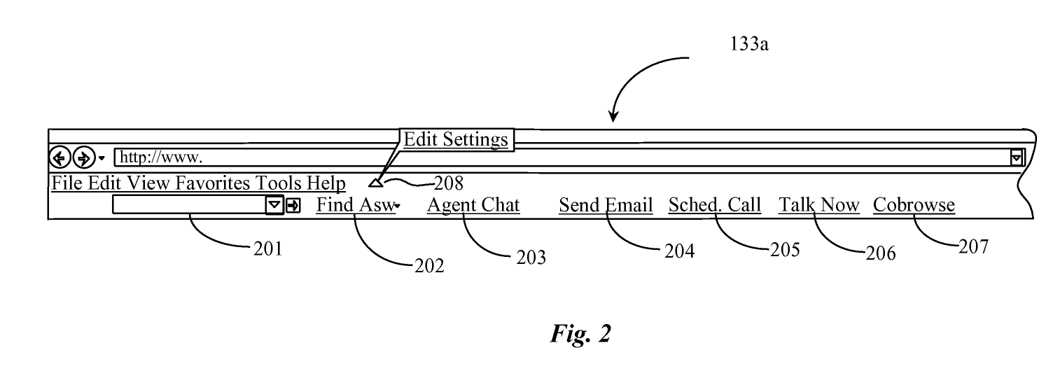

FIG. 2 is a plan view of an option launch container in the form of a browser toolbar 133a according to an embodiment of the present invention. Option launch container 133a is a toolbar extension and may be referred to herein after as toolbar 133a. Toolbar 133a may be installed as a complete toolbar or as an additional row applied to the bottom row of an existing toolbar, or in any of several other versions. In this example, toolbar 133a overlays or overwrites the top title bar area of a browser interface. As such it includes the popular forward and backward navigation buttons. If added as an additional row in the toolbar area, no displacement or overwriting of toolbar display may occur.

Toolbar 133a supports the browser navigation bar and the typical browser menu items like File, Edit, View, Favorites, Tools and Help. Toolbar 133a has a plurality of interactive contact options. A site search box or field is provided and is adapted to enable people to search for knowledge base (KB) articles, forums, and other digitally stored documents and archive files. A dropdown menu may be provided for a user to select a category from the search option menu. An interactive option 202 is provided for help in finding an answer to a question or to live questions presented during interaction. Other interactive options in this example include an interactive agent chat option 203, an email send option 204, a schedule callback option 205, an interactive talk now button 206, and a co-browsing option 207.

The interactive contact options just described are exemplary only. There may be more or fewer interactive option from which to choose. Each interactive option represents a direct channel that could be established between the user invoking the option and the contact center contracted to help the user. Upon installation of the toolbar, each separate channel that is activated displays some type of information that is relevant to the option invoked. Information that might be displayed may include anchor text describing a good time to call. In other embodiment the displayed information may include some basic availability information for live assistance.

Invoking the “talk now” option may result in a Web call to a telephone number enabling routing to live agents. Invoking the co-browse option may put the user in a co-browsing queue that allows a live agent to temporarily have control over a navigation sequence using the “follow me” browsing session method. Invoking the schedule call option allows the potential customer to schedule a time when a live person will call the customer back. Invoking the send email button causes the email application used by the potential customer to launch an email for creation and send. In one embodiment the send email button invokes a third-party Instant Message Application Protocol (IMAP) email account set up and personalized for the customer. Invoking agent chat button 203 brings up a chat interface on the computer of the potential customer. Agent chat is a request for a live chat hosted by an agent. In one embodiment a variety of chat configuration preferences could be elected by the potential customer in order to have some control over the nature of the interaction. For example, the potential customer may want to join a chat in progress with other potential customers. In another embodiment the potential customer may just want a single agent chat session. It should be clear to the skilled person that the variety of communication and access options is quite varied, and will be determined by the nature and strategy of the host.

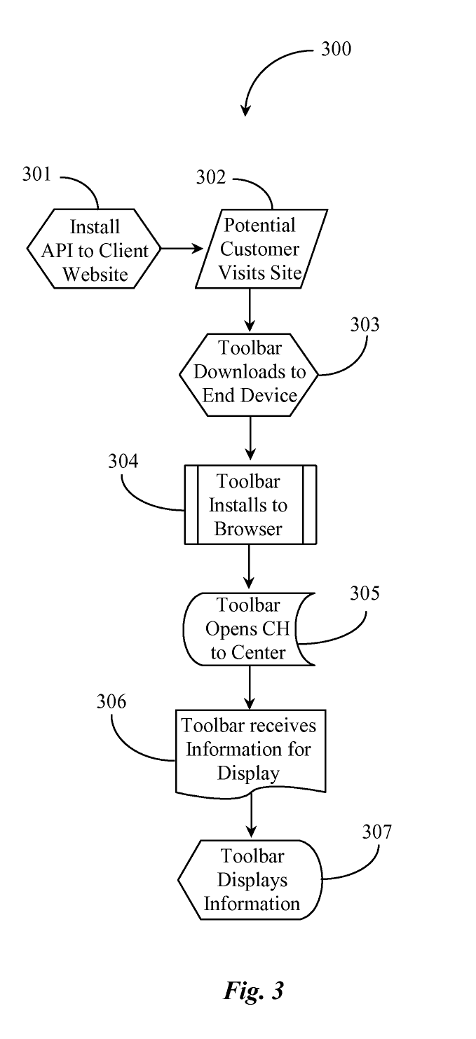

FIG. 3 is a process flow chart 300 illustrating steps for enabling dynamic option container installation and information conveyance through toolbar channels according to an embodiment of the present invention. At step 301 an enterprise administrator installs the API to the enterprise Website. At step 302 a potential customer visits the Website. At step 303 the toolbar downloads to the end device and in step 304, the toolbar self extracts and installs into the browser toolbar area of the browser running on the end device used to access the site.

At step 305 the toolbar opens up one or more channels into the contact center. In one embodiment one channel may be provided over which all toolbar data is propagated. In another embodiment there may be two or more channels dedicated to the type of contact option launching. At step 306 the toolbar receives the information for display and in step 307 the toolbar displays the information. In one embodiment the information display is the estimated waiting time in queue for the talk now option. In one embodiment the displayed information is an indication of which agent will be available for a co-browsing session. In still another embodiment the system displays two or more differing search options in a dropdown menu. Options for searching the site of the contact services provider include but may not be limited to search of knowledge base information, Frequently Asked Questions (FAQs), forum threads, and any other solution-oriented data.

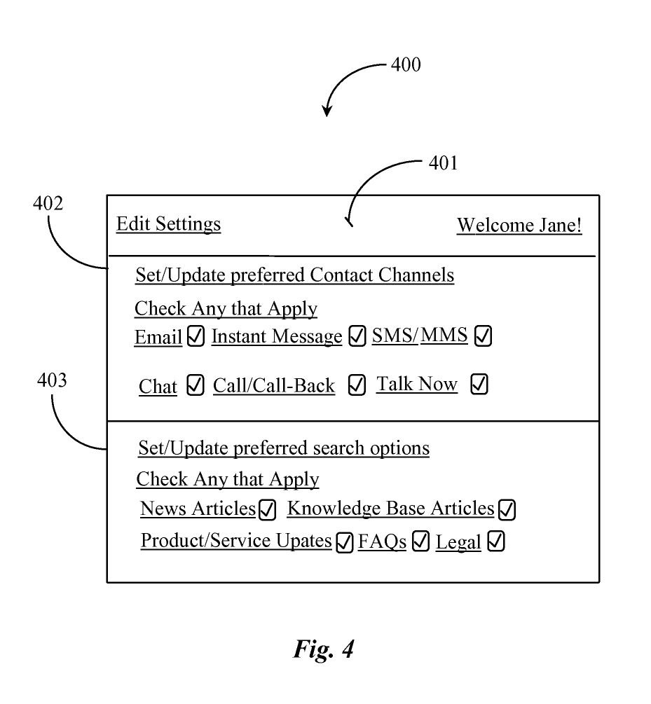

FIG. 4 is a plan view of a configuration interface 400 for configuring or updating toolbar settings according to an embodiment of the present invention. Interface 400 may be invoked by interacting with the edit settings button 208 on toolbar 133a of FIG. 2. In one embodiment, the toolbar is personalized to any potential customer where knowledge of the customer's name is available to the system. Interface 400 has a title bar section 401 that identifies the interface and welcomes the potential customer. In one embodiment a registration option is afforded to the potential customer so that every subsequent visit to the enterprise Website results in toolbar display that is personalized to that repeat visitor.

Interface 400 includes a section 402 for updating and editing contact channel preferences. For example, a potential customer may edit contact channel display to display only the contact channels preferred by the potential customer. In this example all of the offerings are checked indicating that the potential customer wishes to have all of these options available when visiting the enterprise Website. There may be more or fewer offered contact channels without departing from the spirit and scope of the present invention.

Interface 400 includes a section 403 for updating and editing site search options offered to the potential customer. In this example, the options News Articles, Knowledge Base Articles, Product/Service Updates, FAQs, and Legal are all checked. There may be more or fewer search options provided without departing from the spirit and scope of the present invention.

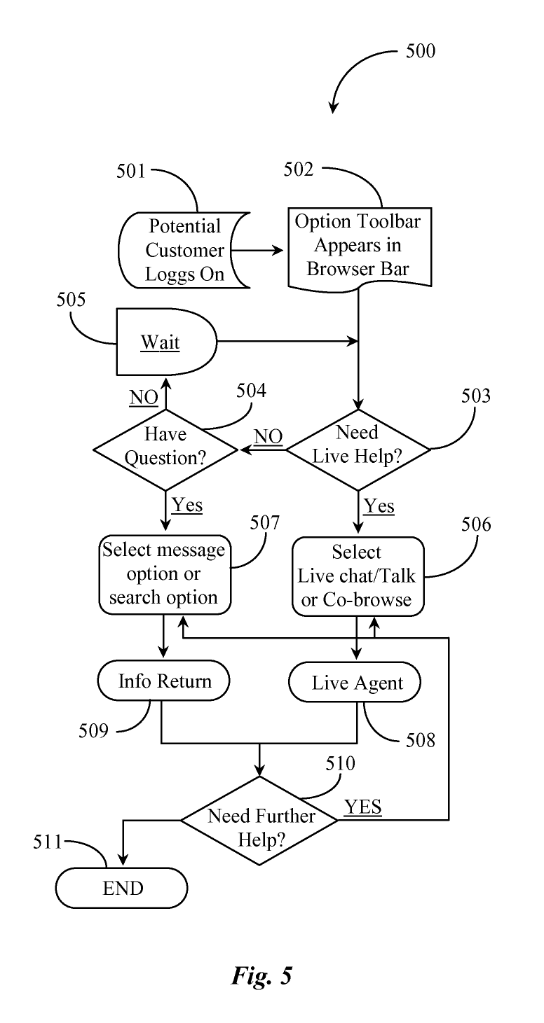

FIG. 5 is a process flow chart 500 illustrating steps for customer interaction with a dynamic option toolbar according to an embodiment of the present invention. At step 501, a potential customer logs on to an enterprise Website that has the API installed. At step 502, the option container or toolbar appears automatically in the browser bar area of the customer's browser. The install process is transparent to the potential customer in one embodiment. In another embodiment installation is a process that includes a configuration and registration step not illustrated in this example. It may be assumed in this example that the potential customer has already configured preferences and has registered to use the toolbar as a convenient way to initiate contact and/or search activities. There may be in various embodiments a variety of conditions under which the toolbar will install at the customer's browser, or not. For example, use may be focused by the enterprise for certain customers, and activation is by customer ID. Some customers may have a token such that arriving at an enterprise website makes the token visible to the website and activate the download of the toolbar. There are a variety of other conditions that might be controlled.

At step 503, the potential customer may decide if she requires live assistance. If the potential customer does not require live assistance at step 503, then she may decide whether or not she has a question that requires an answer. Steps 503 and 504 are not steps that are critically ordered. These are simply the most natural decisions a customer will make when visiting the enterprise Website. If the potential customer has no questions at the time then at step 505 a delay or wait period may transpire before the potential customer decides whether she requires live assistance or has a question. In one embodiment the customer simply will browse the Website and perhaps place an order using automated assistance whereby offerings available in the option launch container (toolbar) are not selected or interacted with. However, the options are always present should the potential customer need live assistance or has a question that requires an answer.

At step 503, if the potential customer decided that live assistance is required, then at step 506 the potential customer selects one of the live options on the toolbar such as live chat, live talk, or co-browse. Chat, Voice, and Co-browse are all live options requiring a live agent. Selection at step 506 results in interaction with a live agent at step 508 over the selected channel.

If the potential customer does not require live assistance but does have a question at step 504, then at step 507 the potential customer may select a messaging option like email or posting the question, or a site search option such as search KB articles, for example. At step 509 any information retrieved as a result of keyword, phrase, or types question submission is returned to the customer at step 509. The search options may respond to both keywords and phrases if not direct questions.

After the potential customer interacts with the system using live or non-live assistance, the potential customer may make a decision whether additional assistance might be required. If no other assistance is required, the process terminates at step 511. If the potential customer has another question or requires live-assistance again, the options are always immediately available in the toolbar as long as the customer is logged on to the enterprise Website. In one embodiment the customer may see product offers or service offers in the toolbar and may then select those options through the toolbar in order to further the process of obtaining or learning more about those offers.

### Proactive Business to Consumer (B2C) Advertising

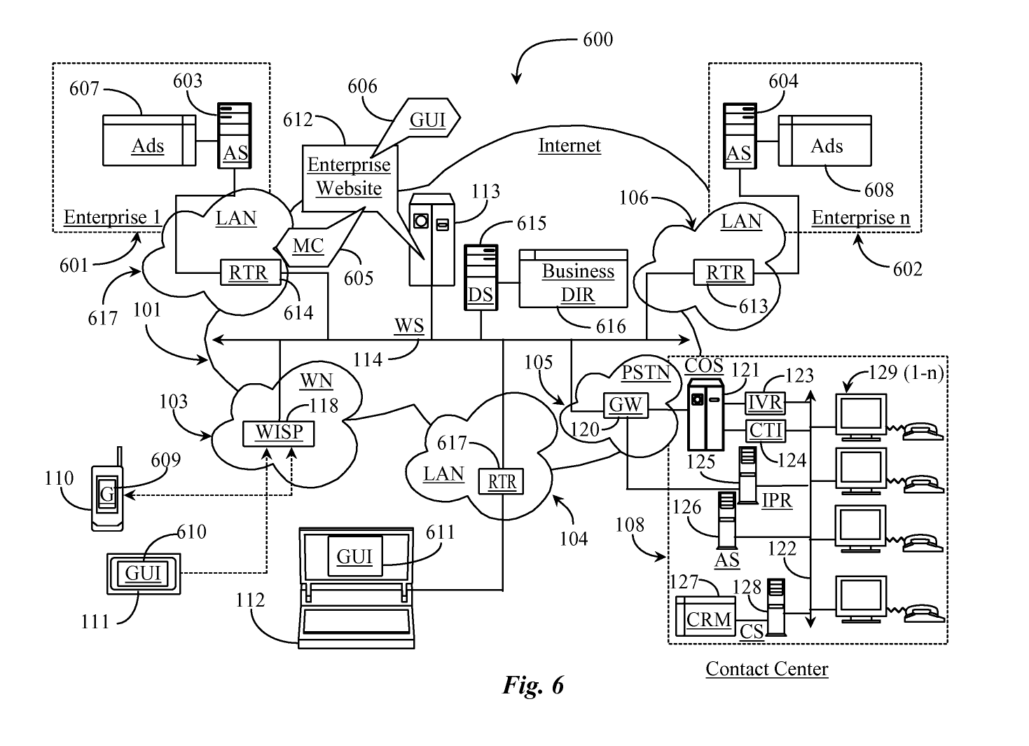

FIG. 6 is an architectural overview of a communications network 600 supporting dynamic business to user connectivity according to another aspect of the invention. Communications network 600 includes Internet network 101, Internet backbone 114, and web server 113 introduced in FIG. 1. Communications network 600 also includes connected sub-networks WN 103, LAN 104, PSTN 105 and LAN 106. An additional LAN 617 is illustrated in this example to complete connectivity for enterprise domains 601 (Enterprise 1) and 602 (Enterprise n). There are numerous elements in FIG. 6 that were introduced in FIG. 1, but have not been changed or modified in description. These elements retain the element numbers assigned in FIG. 1 and shall not be reintroduced to avoid redundancy in the description.

In this embodiment, enterprises 601 and 602 serve advertisements to Website visitors such as those operating network appliances 110, 111, and 112, wherein those ads are relevant to information known about the visitor detected by the advertising system or otherwise pre-known to the enterprise and associated with a current visitor. In this example, enterprise 601 maintains an ad server (AS) 603. AS 603 includes a digital medium coupled thereto or otherwise accessible thereto that is adapted to contain all of the software and data required to function as an advertisement server. AS 603 has a data connection to a data repository 607 adapted to store advertisements for service to visitors over the Internet. AS 603 is connected to Internet backbone 114 through LAN 617 and a data router 614. Ad server 603 may be maintained by a third-party advertising service instead of the enterprise without departing from the spirit and scope of the present invention.

Enterprise 601 maintains an ad server 604. Ad server 604 includes a digital medium coupled thereto or otherwise accessible thereto that is adapted to contain all of the software and data required to function as an advertisement server. Ad server 604 has a data connection to a data repository 608 adapted to store advertisements for service to visitors over the Internet. Ad server 604 is connected to Internet backbone 114 through LAN 106 and a data router 613. Ad server 604 may be maintained by a third-party advertising service instead of the enterprise without departing from the spirit and scope of the present invention.

In one embodiment of the present invention enterprise 601 and enterprise 602 upload created advertisements relative to their products and services to application server 126 connected to LAN 122 within contact center 108. In this embodiment the contact center serves the advertisements to visitors of the enterprise Websites. In this embodiment the enterprises have contracted with the call center to manage sales and service including proactive advertising. Web server 113 hosts an enterprise Website 612. Website 612 may represent the site of enterprise 601 or of enterprise 602 or any other enterprise practicing the invention.

Website 612 has a machine readable instruction or code 605 that is parsed by a visitor's browser application when the visitor first enters the Website. Code 605, when invoked, initiates download and installation of or server run display of a graphics user interface (GUI) 606. GUI 606 may be in the form of a toolbar or a pop-up window or interface. GUI 606 may be a browser plug-in, a thin client download, or a standalone application that is downloaded from the Website. The purpose of the GUI is to enable a visitor to receive immediate contact channel connectivity over which realtime and interactive options may be received to help the visitor fully realize and quickly achieve the goal of visiting the site.

A website visitor operating appliance 110 may download or display a version of GUI 606 as “G” 609. Smartphone 111 includes a GUI 610 adapted as a downloaded or server-hosted version of GUI 606. Laptop 112 has a version of GUI 606 displayed as GUI 611. It is also noted herein that Laptop 112 is connected to LAN 104 and accesses Internet backbone 114 via a data router 618. Each of the visitors has entered Website 612, invoked MC 605 to receive their custom versions of GUI 606. The GUI might be sever-hosted, a plug-in to the visitor browser, or it might be a pop-up interactive window that serves the information and interactive options. In one embodiment ads are served into each visitor's GUIs while they are visiting the Website. As described further above, the ads might be tailored according to visitor attributes and activity.

In a preferred example, contact center 108 handles all of the business for enterprises 601 and 602 including sales, service, and advertising. In this regard, all served advertisements come directly from application server 126 in call center 108. An operator 110 may visit Website 612, invoke code 605 causing a download and display of GUI 609. GUI 609 contains all of the available contact channels and interactive options offered by contact center 108. In one embodiment installation of the GUI in the form of a toolbar or pop-up interactive window is performed only if the visitor agrees to the installation. In another embodiment which may be entirely server-hosted, the GUI in the form of a toolbar or interactive pop-up displays automatically by default each time a visitor access the Website.

In the example mentioned above, enterprises 601 and 602 may configure advertising and upload those configured ads to ad server 126 within call center 108. Application server 126 may include an ad repository (not illustrated) for storing advertisements for clients of the center. In another embodiment, contact center 108 may act as an advertising broker and may send out proactive advertising for all member enterprises. Member enterprises such as enterprises 601 and 602 may be located for clients who have asked for competitive offers for products or services from any advertiser that is a member of the service of the present invention. In this case, a client such as one operating communications device 610 may visit a special Website hosted by contact center 108 and might receive a GUI similar to GUI 606 where a search for products and services could be launched to find enterprises whose products or services are more competitive. Such enterprise resources might be located in a directory server 615 maintained by contact center 108. Directory server 615 includes a digital medium installed therein or otherwise accessible thereto that is adapted to contain all of the software and data required to enable server function as a directory server.

Competing advertisements from member advertisers may be served to potential customers based on preferences, queries, search activities, or some other criteria such as behavior or activity patterns known about the potential customer's Web activity or context dissemination without departing from the spirit and scope of the present invention. Advertisements may be served to potential customers that visit any member Website and have downloaded and opened a GUI adapted to receive the ads. In some cases advertisements may be served to customers that are known to contact center 108 but that have not visited any Website enhanced for practicing the invention. In this case when the customer clicks on or otherwise interacts with an advertisement, that potential customer might be redirected to an appropriate member Website where they may download and install or otherwise access the GUI thereby obtaining the immediate contact information to proceed with the advertisement interaction.

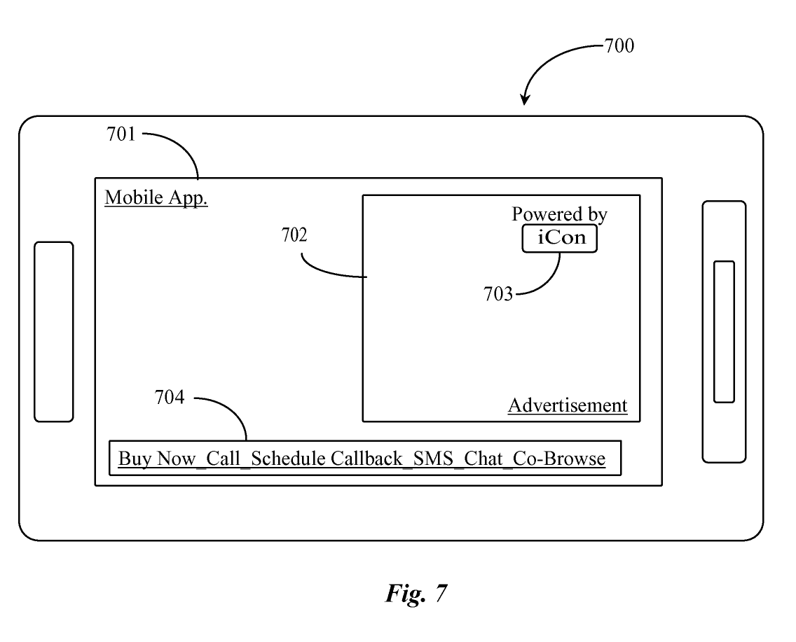

FIG. 7 is a plan view of a mobile device 700 displaying an advertisement including a dynamic option load button according to an embodiment of the present invention. Mobile communications device 700 may be a smartphone, an iPad, a PDA, or some other device capable of accessing and browsing the Internet. The potential customer has a mobile application 701 opened on communications device 700. During the course of working within the mobile application, presumably connected to the Internet network, an advertisement 702 appears as a pop-up window that depicts a visual and textual advertisement with a connection button labeled iCon for I Connect.

Once the potential customer has invoked or otherwise interacted with the iCon button, the available contact options assigned to that advertisement appear in an interactive option bar or menu 704. The potential customer may invoke one or the options from option bar 704 to further the interaction relative to the served advertisement. The contact options might be the same options that would be available if the potential customer had visited the Website of the enterprise that originated the advertisement. In both cases, contact center 108 described in the example of FIG. 1 and in the example of FIG. 6 may be the servicing entity for that potential customer.

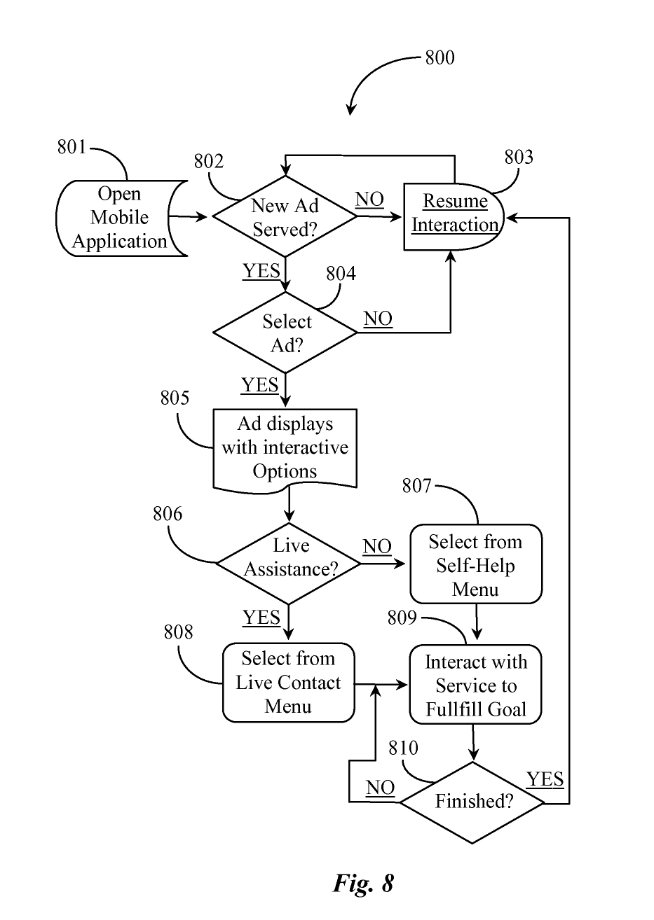

FIG. 8 is a process flow chart 800 illustrating steps for interacting with mobile advertisements according to an embodiment of the present invention. At step 801 a potential customer operating a communications device opens a mobile application while connected online. The mobile application may be configured to receive mobile advertisements served by a third-party advertiser. At step 802, the potential customer determines if a new advertisement has been served into the application GUI. If no advertisement was served, the potential customer might resume interaction at step 803. If an advertisement was served into the mobile application GUI, the potential customer makes a determination at step 804 to invoke the advertisement or not to invoke the advertisement.

If the potential customer decides to ignore the served advertisement, then the process may resolve back to step 803 where the potential customer resumes interaction with the mobile application. If the potential customer is interested in the advertisement and selects the advertisement at step 804, then at step 805 the advertisement displays fully including all of the available interactive options such as those described above with respect to the options bar 704 of FIG. 7. It is assumed that the list of available options will include both live assistance channels and self service channels. At step 806, the potential customer decides whether live assistance is required or not.

At step 806 if no live assistance is required, then at step 807 the potential customer may select from self help options. In this pathway, at step 809 the potential customer interacts with the service via the selected channel to fulfill the potential customer's goal. In the same pathway, at step 810 the potential customer determines if they are finished interacting. At step 810 if the potential customer is finished interacting with the service then the process resolves back to step 803 and the potential customer may resume interaction in the mobile application they are working in. If at step 810, the potential customer is not finished interacting, then the process may loop back to step 809. It is noted herein that the process may also enable the customer or potential customer to move from self help to live assistance while interacting with the ad service provider such as contact center 108 of FIG. 1.

At step 806, is the potential customer determines that live assistance is desired, then the potential customer may select from the live contact menu presented at step 808. The process then moves to step 809 and 810. It is noted herein that a potential customer working with live assistance may still opt to continue in a self service mode during the interactive session.

It will be apparent to one with skill in the art that the option launch container system of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

1. A network-connected server comprising:
software executing from a machine-readable medium for providing functionality;
a web page with links to one or more further pages providing information or services related to a first enterprise hosting the server;
an interface for communicating with a computerized appliance accessing the web page with a web browser; and
wherein the software adds to the browser display at the computerized appliance, automatically in response to access by the computerized appliance, an interactive interface not provided on the web page, the interactive interface providing one or more links to specific information or services.

2. The server of claim 1 wherein the links to specific information or services are links to facilities hosted by the server.

3. The server of claim 1 wherein one or more of the links to specific information or services connect the computerized appliance to a different network-connected server.

4. The server of claim 1 wherein one or more of the links to specific information or services launches an IP telephone call to an agent at a call center hosted by a second enterprise acting on behalf of the first enterprise.

5. The server of claim 1 wherein one or more of the links to specific information or services connects the computerized appliance to a chat session.

6. The server of claim 1 wherein one or more of the links to specific information or services connects the computerized appliance to a service at a call center hosted by a second enterprise acting on behalf of the first enterprise, and to a facility for scheduling a call-back to an IP address or a telephone number.

7. The server of claim 1 wherein one or more of the links to specific information or services launches an email client at the computerized appliance with a pre-stored send-to address.

8. The server of claim 1 wherein one or more of the links to specific information or services connects the computerized appliance to a service at a call center hosted by a second enterprise acting on behalf of the first enterprise, and to a facility for participating in a co-browsing session with an agent at the call center.

9. The server of claim 1 wherein the interactive interface provided to the browser of a connecting computerized appliance is provided on a selective basis, according to information provided by the connecting appliance automatically at the time of connection, or stored at the server about the appliance or a person associated with the appliance identified at the time of connection.

10. The server of claim 9 wherein the server or a third party server to which the computerized appliance may be redirected, downloads an advertisement to the computerized appliance, the advertisement enhanced with interactive links providing the person using the appliance access to more granular material about a product or service subject of the advertisement, and an ability to buy the product or service.

11. A method for customer interaction with a site hosted by an enterprise, comprising steps of:
(a) connecting to the site by a computerized appliance executing a browser application;
(b) providing to the computerized appliance through the browser application a web page; and
(c) providing also to the browser application automatically in response to connection by the computerized appliance an interactive interface having links, not displayed on the web page, to specific information or services.
